(19) United States
(12) Patent Application Publication
(10) Pub. No.: US 2017/0277522 A1
(43) Pub. Date: Sep. 28, 2017

(54) PROVIDING A NETWORK SIMULATION CODE GENERATION SERVICE BY A CLOUD-BASED INFRASTRUCTURE

(71) Applicant: Adrian E. Conway, Weston, MA (US)

(72) Inventor: Adrian E. Conway, Weston, MA (US)

(21) Appl. No.: 15/470,173

(22) Filed: Mar. 27, 2017

Related U.S. Application Data
(60) Provisional application No. 62/313,167, filed on Mar. 25, 2016.

(51) Int. Cl. G06F 9/44; G06F 17/50; H04L 29/08

(52) U.S. Cl. CPC G06F 8/35; H04L 67/10; G06F 17/509; G06F 2217/04

(57) ABSTRACT

A cloud-based computing infrastructure provides a network simulation software code generation service accessible by multiple users. A user-based obfuscation engine provides a network simulation model obfuscation function using masking, steganography, and model decomposition techniques applied to a provided network model to generate an obfuscated network model representation. A user-based clarification engine provides an obfuscated simulation code clarification function applied to obfuscated network simulation code to generate usable unobfuscated network simulation code that is provided to a user. The cloud-based infrastructure executes an operation generating obfuscated network simulation code for an obfuscated network model representation. The generated obfuscated code is provided by the generation service to a user-based clarification engine.

### RELATED APPLICATION

This application claims priority to U.S. Provisional Patent Application No. 62/313,167 filed on Mar. 25, 2016, which is hereby incorporated by reference in its entirety.

### BACKGROUND

Software tools for discrete-event network simulation are widely used in the research, development, analysis, and engineering of computer communication and telecommunication networks and services by researchers, engineers, scientists, students, and others in enterprises such as companies, corporations, educational organizations, and government agencies. They can be employed for various purposes including analyzing new types of networks or design alternatives, optimizing parameters, evaluating cost-benefit trade-offs, experimentation, proof-of-concepts, what-if scenarios, validating protocol correctness, and education. A central benefit of using simulation in such endeavors is that it can economically provide from a cost or time standpoint, a mechanism for analyzing or experimenting with network behavior and obtaining desired simulation outputs. The simulation outputs such as network or application performance measures and packet traces, may be obtained without having to build or modify actual physical networks or conduct field trials. Examples of existing network simulators include Riverbed's NetModeler (formerly OPNET Modeler), OMNeT++, OMNEST, QualNet, ns-2, and ns-3.

Some existing techniques create simulation code or script from a network model. Andrew Hallagan, et al., “An Experiment Automation Framework for ns-3,” and L. Felipe Perrone et al., “SAFE: Simulation Automation Framework for Experiments,” describe the Simulation Experiment Automation Framework (SAFE) composed of an Experiment Execution Manager (EEM) on a server machine and a set of client machines for running simulations. In SAFE, a user interacts with an interface to produce a XML-based language network model description file which is provided to the EEM. The EEM provides the network model file to a client machine where it is provided to a (proof-of-concept) translator that internally generates a “ns-3 script in C++ and Python” which is then run on the client machine to obtain simulation results which are then reported back to the EEM.

Ronald G. Addie, et al., “NetML: Networking Networks,” Ron Addie, “NetmL System for Analysis and Design of Networks,” describes NetML, a general system for network analysis and design that includes various analytical tools. NetML “runs in a browser with all heavy calculations in the cloud (an Internet server or a network of servers).” In “NetML: Networking Networks,” it is mentioned that “it is expected that a tool which converts a NetML document (i.e., a network model) into a script which can be used to run an NS2 (ns-2) simulation will be developed.” “NetmL System for Analysis and Design of Networks” indicates that such a tool has now been developed for NetML to (internally) convert a NetML document into a ns-3 simulation script and then run the simulation.

### SUMMARY

In one embodiment, a method for securely providing a code generation service implemented in a cloud computing environment is provided. The method includes receiving a network model from a user, generating an obfuscated network model based on the network model, and transmitting the obfuscated network model to a network simulation code generation service implemented in a cloud computing environment. The method also includes receiving network simulation code generated from the obfuscated network model, and generating unobfuscated network simulation code from the received network simulation code based on the obfuscated network model.

In another embodiment, a system for securely providing a code generation service implemented in a cloud computing environment. The system includes an obfuscation engine configured to receive a network model from a user, generate an obfuscated network model based on the network model, and transmit the obfuscated network model to a network simulation code generation service implemented in a cloud computing environment. The system also includes a clarification engine configured to receive network simulation code generated from the obfuscated network model, and generate unobfuscated network simulation code from the received network simulation code based on the obfuscated network model.

In another embodiment, a non-transitory machine-readable medium is provide that stores instructions executable by a processing device. Execution of the instructions causes the processing device to implement a method for securely providing a code generation service implemented in a cloud computing environment. The method includes receiving a network model from a user, generating an obfuscated network model based on the network model, and transmitting the obfuscated network model to a network simulation code generation service implemented in a cloud computing environment. The method also includes receiving network simulation code generated from the obfuscated network model, and generating unobfuscated network simulation code from the received network simulation code based on the obfuscated network model.

### BRIEF DESCRIPTION OF THE DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 is a block diagram of an exemplary system to provide a user-based obfuscation function, a user-based clarification function, and a cloud-based network simulation code generation service, in an embodiment of the present invention;

FIG. 2 is a flow diagram of a process to provide a user-based obfuscation function, according to an exemplary embodiment;

FIG. 3 is a flow diagram of a process to provide a user-based clarification function, according to an exemplary embodiment;

FIG. 4 is a flow diagram of a process to provide a cloud-based network simulation code generation service, according to an exemplary embodiment;

FIG. 5 is a flow diagram of a process to provide a method to decompose a network simulation code generation program into subprograms and determine network model information that is referenced by each subprogram according to an example embodiment;

FIG. 6 schematically depicts example network models for use with a user-based obfuscation function according to an example embodiment;

FIG. 7 illustrates a network diagram depicting a system for implementing a cloud-based service providing a network simulation code according to an example embodiment; and

FIG. 8 is a block diagram of an exemplary computing device that may be used to implement exemplary embodiments of a cloud-based service providing a network simulation code described herein.

### DETAILED DESCRIPTION

Existing network simulators have differing levels of user friendliness. Some simulators, such as OPNET, provide a graphical user interface (GUI) and extensive documentation for users to develop network simulation models, run simulations, and view or export simulation results. Other simulation tools, such as ns-3, come as a software package and require that network simulation code (e.g., main.cc) or script be developed by a user using the provided application program interface (API) and accompanying documentation. Such an API assumes, in general, a higher level of expertise on the part of a user compared to tools that provide a user-friendly GUI. It can also require much effort and be time consuming for a user to become proficient with using a network simulation API.

To reduce the time and effort needed for building and running network simulations using simulators that come as a software package with an API, efforts have been made to develop tools and techniques for automating the steps involved. Such tools and techniques include GUI or web-browser interfaces for specifying network models, description techniques for specifying network models, frameworks for running sets of simulation experiments, and generators (translators, converters or adapters) for automating the process of developing network simulation code or scripts for network models in terms of API.

Apart from using generators to provide network simulation code or scripts to then run simulations and obtain simulation results, the machine generation of simulation code or scripts for network models can, in itself, also be of utility to users for a number of other related purposes. For example, prior to running a simulation, a user may have the need to combine machine-generated simulation code with other code that is not part of a network simulation software package release. Such other code can include proprietary source code or source modules belonging to a user or a user's organization, restricted or “classified” source code, open source code from the software package release that has been modified by the user, or other open source or proprietary code obtained from others that is not included in a simulation package. A user may also want to obtain machine-generated code to serve as a basis for making their own custom changes or additions before running it or combining it with other code. A user may also want to obtain machine-generated code for network simulations without having to run their simulations on the systems of other parties. A user may also want to obtain machine-generated code for his or her own use such as for teaching, training, or learning purposes.

Lorenzo Saino, et al., “A Toolchain for Simplifying Network Simulation Setup” describes the Fast Network Simulation Setup (FNSS) toolchain software library for defining a network topology, configuring parameters, adding traffic sources and scheduled events, and exporting the configured simulation scenario to an XML file which may then be presented to adapters provided in FNSS that parse XML files to deploy simulation scenarios to target simulators such as ns-2, ns-3, and others. This functionality provides means for generating simulation code from network models.

Peter Weiss, et al. “Topology Generator” describes a ns-3 topology generator project that aims to provide a GUI tool for a user to build a network simulation model and generate corresponding ns-3 simulation code. Mohit Tahiliani, et al. “Network Simulation Helper (NetSH) for ns-3” and Avinash K., et al. “User Manual for NetSH Tool” describe a similar GUI tool named NetSH.

Although apparatus and methods such as described in Lorenzo Saino, et al. and Peter Weiss, et al. include desired means to generate simulation code from a network model, the tools in these references are provided as user-based tools. With the proliferation and availability of cloud-based infrastructure computing resources and environments that are both economic and reliable, it is desirable to provide cloud-based means or services for users to generate network simulation code or scripts from user-provided network models. Cloud-based apparatus and methods such as used in SAFE (see Andrew Hallagan, et al. and L. Felipe Perrone, et al.) and NetML (see “NetML: Networking Networks” and “NetmL System for Analysis and Design of Networks”) could be extended by a skilled person to provide their internally generated simulation code or scripts to users. User-based apparatus and methods such as described in Lorenzo Saino, et al. and Peter Weiss, et al. could be adapted by a skilled person to provide equivalent cloud-based services. However, some users may be hesitant, unwilling, or unable to use such cloud-based services since their use can expose confidential, proprietary, or restricted information to untrusted or competing parties when network model information is transferred from a user to a cloud-based computing infrastructure, server, or distributed set of servers of another party.

Even though a network model can be communicated securely from a user to a cloud-based simulation code generation service in an encrypted form or over a secure network connection, network model information can be exposed after it has been received by a generation service when it is presented in an insecure form as input to a generation program or process running on a computing device. Moreover, network model information can also be exposed in a cloud-based computing device during the execution of a generation operation itself when network model information is stored in processor caches or memories. Moreover, code or script generated by a cloud-based generation service can contain network model information that can be exposed at the output of a generation program or process before it is communicated to a user. For certain types of users, such potential exposure may be undesirable or unacceptable even though cloud computing infrastructure service providers themselves may have security measures of their own in place. For example, a corporate or military user of a cloud-based generation service may be concerned if network model information such as specific network names, labels, addresses, parameter values, or topological details could be exposed.

To meet the possibly conflicting desires of providing a cloud-based service for users to generate simulation code or scripts from user-provided network models and not expose network model information in the cloud, it is desirable and of utility to provide apparatus and methods to generate simulation code or scripts in the cloud from user-provided network models while obfuscating network model information during the process. Exemplary embodiments described herein provide a function for a user to obfuscate details of a network simulation model. Exemplary embodiments also provide a cloud-based code generation service that can operate on an obfuscated network model to generate obfuscated simulation code or script in which network model details remain obfuscated in the simulation code or script that is generated. The systems and methods described herein includes mechanisms so that obfuscated details of a network model remain obfuscated during the execution of a generation operation itself. Exemplary embodiments provide a function to convert obfuscated simulation code or script to normal simulation code or script that corresponds to the original unobfuscated network model.

As used herein, the term “model” is a representation of a system or process. A model, as used herein, may include a mathematical, dynamical, or logical representation of a system or a process. A model may also include a representation of the operation or behavior of the system or process.

As used herein, the term “network model” is a model (a representation) of a physical network, such as a computer network, the Internet, a computer-communications network, a telecommunication network, or a part thereof, for example a backbone network, an access network or the like. A network model may include object-based representations of components of the physical network. As used herein, the term “network model” is representation of components of a network or components that share a network or resources on the network. Network model, as used herein, also includes a representation of the topology of a network, including nodes, links between nodes, etc. A user may define a network model using a graphical user interface that includes graphical representations of various network components. A user may define a network model using software code. Network model may also be referred to herein as “model.”

As used herein, the term “network simulator” is a tool, implemented, for example, as a software program or software library/package, for constructing and exercising (i.e., running or executing) a network model to simulate or imitate the operation, interaction and behavior of the components in a physical network.

As used herein, the term “network simulation model” or “network simulation code” may be a network model that may be exercised (i.e., run) by a network simulator.

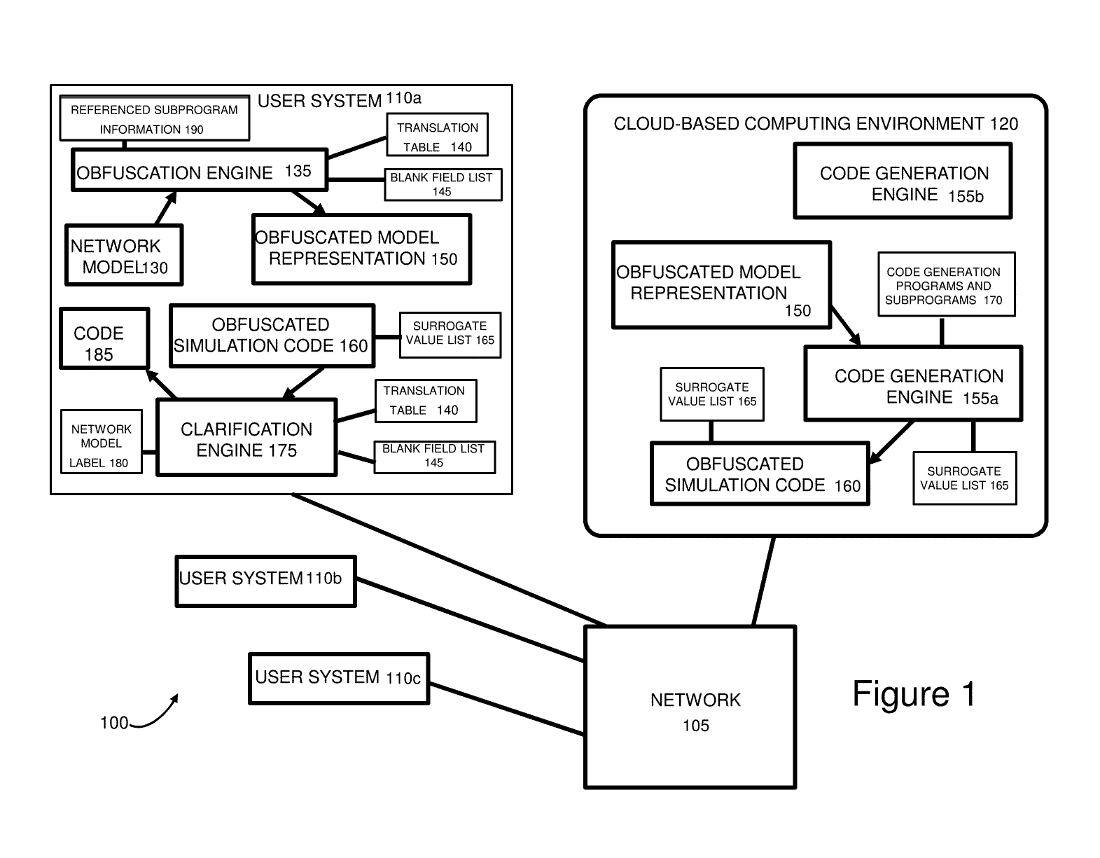

As used herein, the term “code generation service” refers to a service that generates code based on an input. A code generation service may be implemented as a software program or software code. A code generation service may be a network simulator program or engine. A code generation service may include various components, for example, the components of system 100 described in connection with FIG. 1 below.

As used herein, the term “network simulation code” refers to simulation code or simulation script generated by a code generation service or network simulator. The network simulation code simulates or imitates the operation, behavior, and interaction of the components of a network model inputted in the code generation service or network simulator.

As used herein, the term “network simulation code generation service” refers to a service that generates network simulation code based on an inputted network model to simulate or imitate the operation, behavior, and interaction of the components of the inputted network model, where the network model includes representations of components and topology of a physical network.

The term “program” refers to a software code generation program or subprogram that generates simulation code.

### EXEMPLARY EMBODIMENTS

In one embodiment, a user-based network model obfuscation engine is provided to allow a user to generate an obfuscated network model representation from a network model. A cloud-based network simulation code generation service, supported by one or more cloud-based code generation engines, is provided to generate obfuscated network simulation code corresponding to obfuscated network model representations. A user-based network simulation code clarification engine is provided to allow a user to generate a body of usable unobfuscated network simulation code from bodies of obfuscated network simulation code.

The Obfuscation Engine

The network model obfuscation engine of the present invention operates on a network simulation model to generate an obfuscated network model representation that is provided to the code generation service. In the obfuscated representation, the network information of the original model can be masked or obscured. Masked information is information that is completely hidden if observed by a hypothetical observer. Obscured information is information that lacks value in terms of certainty if observed by a hypothetical observer. For example, if a network node name is changed from “Philadelphia” to “nodel”, then knowledge of the name nodel provides no information regarding the real significance of the node. If a node name is converted from “Philadelphia” to an obscured steganographic representation such as {Boston, New York, Philadelphia, Washington}, then a loss of certainty is introduced as to the actual node name since to an observer it could be either Boston, New York, Philadelphia, or Washington.

Some types of model information can be amenable to masking, while some other types of information may not be amenable to masking but can be amenable to obscuring. The obfuscation engine can employ information obscuring, information masking, or a combination of both obscuring and masking, to generate an obfuscated network model representation.

Masking Information

Network model information that can be masked includes certain types of network model options and parameter values. The types of model options or parameter values that can be masked by the obfuscation engine include those where changes in the choices or values do not affect the structure or form of the statements of the network simulation code corresponding to the network model. Under this insensitivity condition, simulation code can be constructed for a network model without having to know the actual option choices or parameter values contained in the network model since these choices or values do not affect the structure or form of the constructed simulation code. Hence, these option choices or parameter values may be masked in a model that is provided to a code generation service.

In some embodiments, model option choices that may be masked by an obfuscation engine include choices among protocol options (e.g., TCP Reno or TCP New Reno), packet error models, propagation delay models, propagation loss models, fading models, mobility models, handover algorithms, scheduling algorithms, and rate control algorithms. In some embodiments, parameter values that may be masked by an obfuscation engine include network node names, link names, sub-network names, IP addresses, port numbers, MAC addresses, circuit labels, attributes of model options, link end-point node name pairs, network interface device node location names, and application-layer traffic source and sink node name pairs. Various methods can be employed to mask model option choices or parameter values in the context of providing a code generation service. Methods, to be described below, include using surrogate representations, encrypted representations, and ‘blank’ representations.

In an embodiment, model option choices or parameter values may be replaced with surrogate representations. One or more distinct surrogate representations may be used to mask a particular option choice or parameter value. Surrogate representations may be automatically generated randomly by an obfuscation engine, selected by a user with the assistance of a GUI tool that can be provided to the user by the obfuscation function or the code generation service, or specified manually by a user. For example, a network node name may be changed from “area51” to “nodea”, a network node name may be changed from “fbi” to either “nodeb” or “nodew”, a transmission link name may be changed from “area51-fbi” to “linkl”, a transmission link end-point node name pair may be changed from {area51, fbi} to {nodex1, nodex2}, an IP address may be changed from “172.16.4.1” to “1.2.3.4”, a channel or link data rate string value such as “308 Mb/s” may be changed to “123 b/s”, and a scheduling algorithm option choice may be changed from “round-robin” to “my_schedule.”

In one embodiment, an obfuscation engine employing surrogate representations can create a translation table, or other equivalent or similar data structure, to record the identity of model options or parameters that have been changed, the original model option choices or parameter values, and the corresponding surrogate representations that are used. This translation table can be provided to the clarification engine. An example translation table is shown below in Table 1. In some embodiments, an original network model value or parameter may have a single associated surrogate value. In some embodiments, an original network model value or parameter may have multiple associated surrogate values or an associated set of surrogate values.

TABLE 1
Example translation table

| | ORIGINAL | |
|---|---|---|
| IDENTITY OF DATA FIELD | VALUE | SURROGATE VALUES |
| network name | cia-network | mynetwork |
| node name | area51 | nodea |
| node name | fbi | either nodeb or nodew |
| node name | langley | nodec |
| link name | area51-fbi | link1 |
| link name | fbi-langley | link2 |
| link end-point node | {area51, fbi} | {nodex1, nodex2} |
| names of link area51-fbi | | |
| link end-point node | {fbi, langley} | {nodex3, nodex4} |
| names of link fbi-langley | | |
| data rate of link area51-fbi | 308 Mb/s | 123 b/s |
| delay in link area51-fbi | 355 ms | MilliSeconds (5) |
| data rate of link fbi-langley | 348 Mb/s | 4 b/s |
| delay in link fbi-langley | 360 ms | MilliSeconds (6) |
| simulation time in seconds | 612 | 7 |

If the same surrogate value is used whenever referring to a particular node, a third-party may be able to identify the network's topology. By using different surrogate values for the same original network value or parameter, the system described herein can also obfuscate the network's topology. For example, as shown in Table 1, the original node name “fbi” is associated with surrogate values “nodeb” or “nodew.” The obfuscation engine while generating the obfuscated code replaces the node “fbi” sometimes with “nodeb” and other times with “nodew.” A third party viewing the obfuscated code is unable to realize that nodeb and nodew refer to the same node in the original network model, and therefore, the third party is unable to identify the network topology.

In some types of masking performed by embodiments, model option choices or parameter values may be replaced with corresponding individually encrypted representations. Indicators such as flags or semaphores may be included in an obfuscated network model to indicate model options or parameters that are provided as encrypted choices or values. When encryption is used, a translation table may not be required. Encrypted representations may be generated by an encryptor that is included in or appended to the obfuscation engine. A corresponding decryptor can be included in or appended to the clarification engine (described in detail below).

In an embodiment employing masking, the obfuscation engine can replace model option choices or parameter values with corresponding ‘blank’ or null values. Blank values can be indicated by using, for example, a null character, a recognizable string value such as, e.g., “blank”, or a recognizable or peculiar number such as “12341234” or “3.1415926”. An obfuscation engine employing blank values can create a list (a ‘blank field list’), or other equivalent or similar data structure, to record the identity of model option choices or parameter values that have been changed to blanks and the corresponding original values of the model option choices or parameter values. This blank field list can be provided to the clarification engine.

In one embodiment, model option choices or parameter values of a network model can be masked using a mixture of surrogate representations, encrypted representations, and blank representations.

Obscuring Information

Some types of network model information may not be amenable to masking. For example, network topology information such as the number of (population) of each type of network element such as network nodes, routers, switches, sub-networks, base stations, client devices, servers, network interface devices, communication links, application-level traffic flows between sources and sinks, and so on. Such network topology population information may not be amenable to masking since the absence of population information may preclude the ability to generate obfuscated simulation code that corresponds at least in structure and form to that of network simulation code corresponding to the network model. However, network model information that may not be amenable to masking may be amenable to obscuring.

Various methods can be employed by the obfuscation engine of the present invention to obscure network model information in the context of providing a code generation service. Methods, to be described below, include a steganographic technique and a network model decomposition technique.

Obscuring with a Steganographic Technique

In some embodiments, network and application-level topology information for a network model can be obscured by a steganographic technique in which an obfuscated network model representation is constructed by the obfuscation engine by adding the network model provided by a user to a set of superfluous network models having differing network and application-level topologies and also adding to each model in the set a unique label which can be used to distinguish the original network model from the superfluous models. The unique label applied to the original network model can be provided by the obfuscation engine to the clarification engine.

By adding a network model to a set of superfluous network models having differing network and application-level topologies, the topological information of the original network model is obscured since a hypothetical observer of the set of models, who could be an untrusted or competing party, would not be able to discern with certainty which model in the set is the original network model. The level of uncertainty of the observer can be increased by increasing the number of superfluous models included in the obfuscated network model representation. In some embodiments, it may be feasible to utilize a large number of superfluous models in this steganographic technique since the storage required for models of typical sizes is not excessively large.

Embodiments may employ various methods to generate a set of superfluous network models. For example, a machine-implementable method may be to embed the original network model in a larger network model, and then randomly generate a number of superfluous related models by perturbing the larger model by randomly deleting certain random numbers of network model elements such as nodes, links, sub-networks, and application-layer traffic flows.

When a network model is obfuscated by applying the steganographic technique, the obfuscated network model representation, consisting of a set of labeled network models that includes the original network model, can be provided by the obfuscation engine to any one of the existing code generation engines as a set of models. Alternatively, the models in the set can be provided by the obfuscation engine to more than one code generation engine by distributing the models in the set across several code generation engines.

Obscuring with Model Decomposition

In one embodiment, network and application-level topology information for a network simulation model can be obscured with a network simulation model decomposition technique as described herein. In the simulation model decomposition technique, the obfuscation engine decomposes a network simulation model into an ordered set of simulation sub-models, where each sub-model only contains a portion of the network and application-level topology information of the original network model, and where each sub-model can be labeled with (or can inherit) the network model label associated with the original network model. Additionally, each sub-model can also be labeled with a sequence number that denotes its placement in the ordered set of sub-models.

For the purpose of realizing the model decomposition technique, the cloud-based computing environment can support multiple instances of a code generation engine, where the number of engine instances can be made equal to the number of sub-models used in the decomposition technique. The physical location of these instances may be physically diverse. Each sub-model, together with its network model label and sequence number, can then be provided by the obfuscation engine to a different code generation engine instance.

By decomposing a network model into a set of sub-models and providing the sub-models to different code generation engine instances that can be at diverse locations, the topological information of the network model is obscured since a hypothetical observer of a sub-model at a particular code generation instance would only be able to see a portion of the network model information.

Various approaches can be taken to decompose a user-provided network simulation model into an ordered set of simulation sub-models. In some examples, a network model can be decomposed in accordance with how a network simulation code generation program can be decomposed into subprograms. In some examples, a code generation program can be decomposed into a sequential set of subprograms, where each subprogram only requires a portion of network model information. More specifically, a code generation program P for an abstract network model consisting of a set of abstract information A can be decomposed into an ordered set of subprograms {P(1), P(2), . . . , P(S)}, where subprogram P(i) only references a subset A(i) of the information A, where i=1, . . . , S, and S is the total number of subprograms in the decomposition. With such a simulation code generation program decomposition, a user-provided network simulation model M consisting of a set of information B can be decomposed into S sub-models, where sub-model M(i) consists of a set of information B(i), where B(i) consists of the set of information at the intersection of the set A(i) and the set B.

The subprograms P(1), . . . , P(S), corresponding to a particular decomposition of a network simulation code generation program used by a code generation service, can be created off-line by the code generation service provider and provided to code generation engines.

The sets of information A(1), . . . , A(S) corresponding to subprograms P(1), . . . , P(S) can be determined off-line by the code generation service provider and provided to obfuscation engines.

The obfuscation engine can decompose a received network model M into sub-models by creating sub-models M(1), . . . , M(S), where sub-model M(i) can be created by setting M(i) to the information that is contained in B(i).

Various approaches can be taken, for example, by a service provider, to write a network simulation code generation program. For the purpose of applying a model decomposition technique for obscuring, it may be useful to write a network simulation code generation program in terms of an ordered series of program portions, program parts, or subprograms, that each require only a portion of network model information. In one example embodiment, an abstract network model can be partitioned into a set of abstract sub-networks and a code generation program can be written in parts to first generate network simulation code for each abstract sub-network separately, then generate simulation code to link the abstract sub-networks together, and then generate simulation code to add routing functionality to the abstract nodes of each sub-network. Then simulation code is generated to add abstract application-layer traffic that is local to each abstract sub-network. The system can then generate simulation code to add abstract inter-sub-network application-layer traffic, and then generate simulation code to create simulation outputs or logging. Such a manner of network simulation code generation by parts can support model decomposition since each part only requires a portion of network model information.

Simultaneous Masking and Obscuring

Masking techniques and obscuring techniques performed by embodiments can be combined in various ways by an obfuscation engine to form an obfuscated network model representation. In one embodiment, an obfuscated network model representation can be constructed by first applying the steganographic technique in which the network model is added to a set of superfluous network models, and then applying masking to the option choices and parameter values of every model in the set of models. The resulting obfuscated network model representation, consisting of a set of labeled masked network models that includes a masked version of the original network model, can be provided by the obfuscation engine to any one of the code generation engines as a series of models.

By applying masking to every model in a steganographic set, a hypothetical observer of the set of models is not able to discern, through the presence or absence of masking, which model in the set is the original model.

In one embodiment, an obfuscated network model representation can be constructed by first applying the model decomposition technique in which an ordered set of sub-models is constructed, and then applying masking to the option choices and parameter values of every sub-model. With a cloud-based computing environment that provides multiple code generation engine instances, each masked sub-model can then be provided to a different instance of a code generation engine.

In an embodiment, an obfuscated network model representation can be constructed by first applying the steganographic technique in which the network model is added to a set of superfluous network models, then applying the model decomposition technique to each model in the set of models to create a set of ordered sub-models for each model in the set where each sub-model is labeled with the label of its parent model and its sequence number in the set of ordered sub-models, and then applying masking to the option choices and parameter values of every sub-model. With a cloud-based computing environment that provides at least D code generation engine instances, where D is the number of sub-models into which a model is decomposed per the decomposition technique, the masked sub-models can be provided by the obfuscation engine to a set of D code generation engine instances, which can be numbered from 1 to D, in such a manner that a sub-model with a label that contains the sequence number i is provided to the code generation engine that is numbered i.

In one embodiment, the model obfuscation function or engine and any associated tables, lists, or subprogram information, may be integrated with or constitute a part of a user-based GUI tool or web-browser interface tool that is intended for a user to build network models. A user-based GUI tool or web-browser interface tool may be provided to a user by a code generation service. In some examples where a network model is built in steps, such as when a GUI tool or web-browser interface tool is used, the obfuscation engine may implement masking in a series of steps where model option choices or parameter values are masked in steps as the network model is built by a user in steps.

The Code Generation Service

The cloud-based network simulation code generation service of the present invention is provided via a cloud-based computing environment that may be managed by a network simulation code generation service provider. The cloud-based computing environment includes computing and storage resources. The environment is accessible over a network by users. The environment includes one or more simulation code generation engine instances that may have physically diverse geographic locations. A code generation engine can be a physical or a virtual computing device. A code generation engine can be provided with a simulation code generation program that writes network simulation code for a given network model. The simulation code that is written by a simulation code generation program conforms in form and structure to the API of a given simulation code package. Using a provided simulation code generation program, a code generation engine can operate on a received obfuscated simulation network model representation to generate a corresponding body of obfuscated network simulation code. The generated body of code may be written to a text file.

In one embodiment a code generation engine can be provided with several different network simulation code generation programs to apply to different types of obfuscated network model representations that are received from the obfuscation engine. One simulation code generation program can be for an obfuscated network model that has not been decomposed into sub-models. A set of other simulation code generation programs, which can be numbered from 1 to D, can be for obfuscated network model representations that correspond to obfuscated sub-models in a network model decomposition, where the program numbered d is intended for an obfuscated network model representation that has a label that contains the sequence number d. The different simulation code generation programs may be provided to a code generation engine by the code generation service provider.

In response to receiving an obfuscated network model representation from the obfuscation engine, a network simulation code generation engine can select the appropriate simulation code generation program to apply based on the type of the received obfuscated network model representation. The selected program can be executed by the code generation engine to generate a body of obfuscated network simulation code that can be provided by the code generation engine to the clarification engine.

When surrogate representations or encryption is used for masking in a received obfuscated network model representation, masked model option choices or masked parameter values remain masked throughout the execution of a network simulation code generation program. Model options or parameter values that are masked in an obfuscated network model representation can appear as masked options or masked parameter values in the corresponding obfuscated network simulation code that is written by a code generation program. Masked options or masked parameter values appearing in the obfuscated network simulation code can also be delineated in the obfuscated code using predefined headers and trailers that can be recognized by the clarification engine.

When blank values are used for masking in a received obfuscated network model representation, a code generation engine can recognize model option choices or parameter values that have been obfuscated using blank representations by identifying model fields that have blank values. To enable the representation of blank values in generated simulation code, a code generation engine can replace the blank values in a received obfuscated network model representation with distinct surrogate values that can be automatically generated by a code generation engine itself. A code generation engine can create a surrogate value list to record the specific model options or parameter fields that have been identified as being blank and the corresponding distinct surrogate values that the blanks have been replaced with in the obfuscated network model representation. The code generation engine can provide the surrogate value list to the clarification engine by appending it to the body of obfuscated network simulation code that is generated by the code generation engine.

The production of each body of obfuscated network simulation code by a code generation engine is, in general, not computationally intensive since it mainly involves writing strings of simulation code to lines in a text file which is not computationally complex. The code generation service provider can provide the generation service to multiple users. Effectively, the cloud-based generation service is provided in a multi-tenant cloud-based computing environment, where multiple tenants refers to the users that are able to separately request the simulation code generation service to perform respective simulation code generations using individual users' corresponding obfuscated network models. Generally, the cloud-based code generation service allows concurrent execution of network simulation code generations that can be based on different obfuscated network models.

The Clarification Engine

The clarification engine of the present invention operates on bodies of obfuscated network simulation code provided by the code generation service to generate a body of normal unobfuscated simulation code corresponding to the original network model provided by a user. In response to receiving a body of obfuscated network simulation code from the code generation service, the clarification engine can first determine from the body of code if it contains a network model label that corresponds to a superfluous network model. If it does, then the body of code can be discarded. If a body of code remains and it contains a sequence number, then the body of code corresponds to that of an obfuscated sub-model and can be stored until all bodies of code for the obfuscated sub-models in the decomposition have been received by the clarification engine, and if all bodies of obfuscated code for the sub-models have been received, then the clarification engine can concatenate the stored bodies of obfuscated code in the order of their sequence numbers, unmask any model option choices or parameter values that has been masked, and provide the resulting body of unobfuscated network simulation code to the user. If a body of code remains and it does not contain a sequence number, then the body of code corresponds to an obfuscated network model that has not been decomposed and the clarification engine can unmask any model option choices or parameter values that have been masked and provide the resulting body of unobfuscated network simulation code to the user.

In one embodiment, if a model option choice or parameter value is masked by the obfuscation engine using a surrogate representation, a surrogate representation in the body of obfuscated code is replaced with the original choice or value that is given in the translation table (e.g., Table 1) provided by the obfuscation engine. Alternatively, if a model option choice or parameter value is masked using an encrypted representation, an encrypted representation in the body of obfuscated code is replaced with the decrypted choice or value. In one embodiment, if a blank representation is used by the obfuscation engine and where a code generation engine replaces blank model option choices or parameter values with surrogate representations, a surrogate representation in the body of obfuscated code is replaced with the original choice or value which can be deduced from the blank field list provided by the obfuscation engine and the surrogate value list provided along with the body of obfuscated code provided by the code generation engine. More specifically, the clarification engine can use the blank field list provided by the obfuscation engine, which provides a list of model options and parameters together with their corresponding original values, and the surrogate value list provided by a code generation engine, which provides a list of model options and parameters together with their corresponding surrogate values, to form a conversion table. The conversion table provides a list of surrogate values and their corresponding original values, to clarify the obfuscated simulation code provided by the code generation engine by replacing the surrogate values inserted by the code generation engine with the corresponding original values provided by the obfuscation engine.

For example, consider a network model that has a model parameter LinkDataRate with a value of 10 Mbps and the value of this parameter is provided by the obfuscation engine to a code generation engine as a blank. The obfuscation engine provides a blank field list entry of (LinkDataRate, 10 Mbps) to the clarification engine. When the code generation engine writes a value for LinkDataRate in the code that it is generating, it can insert a surrogate value of, e.g., 1234.5 bps and provide a surrogate value list entry of (LinkDataRate, 1234.5 bps) to the clarification engine. The clarification engine can then use the pair of list entries (LinkDataRate, 10 Mbps) and (LinkDataRate, 1234.5 bps) to convert the surrogate value of 1234.5 bps to the original value of 10 Mbps.

In an embodiment performing obfuscation and using surrogate representations, the location of a masked option or masked parameter value in a body of obfuscated code can be found by searching for character strings of surrogate representations. The surrogate representations to search for can be provided by the translation table that can be provided by the obfuscation engine.

In an embodiment performing obfuscation and using blank representations, the location of a surrogate representation inserted by a code generation engine can be found by searching for character strings of surrogate representations. The surrogate representations to search for can be provided by the surrogate value list that can be provided along with the body of obfuscated code that is provided by the code generation engine.

In an example embodiment, the location of masked options or parameter values appearing in obfuscated network simulation code may be found by searching for predefined headers and trailers that may be included in obfuscated code.

In one embodiment, the clarification engine may be integrated with or constitute a part of a user-based GUI tool or web-browser interface tool that is intended for a user to build network models and obtain corresponding network simulation code using a cloud-based code generation service.

By allowing a user to generate a body of normal unobfuscated network simulation code from obfuscated network simulation code using the clarification engine described herein, a user is able to obtain normal usable simulation code that corresponds to their original network model.

### Example 1

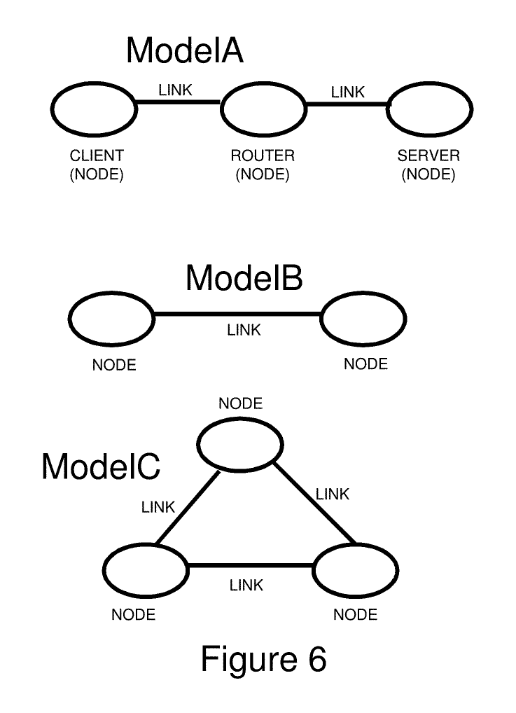

A non-limiting example described below can serve to illustrate the process of obscuring, masking, obfuscated code generation, and clarification. Consider a network composed of a server node, a client node, a router, and two bidirectional links, as shown at the top of FIG. 6. The model for this network is denoted as ModelA (e.g., ModelA of FIG. 6). In the obfuscation step, first the topology of ModelA is obscured by adding two superfluous network models denoted as ModelB (e.g., ModelB of FIG. 6) and ModelC (e.g., ModelC of FIG. 6), as shown in FIG. 6. Then the options and parameters of all of the models are masked. The masked models are denoted as ModelA*, ModelB*, and ModelC*, respectively. ModelA can be specified by a simulation network model description such as:

network_name: cia-network
network_nodes: area51, fbi, langley
network_links: area51-fbi, fbi-langley
network_link_endpoints(area51-fbi): area51, fbi
network_link_endpoints(fbi-langley): fbi, langley
set_attribute(link_type, area51-fbi) = “bidirectional”
set_attribute(link_type, fbi-langley) = “bidirectional”
set_attribute(node_type, area51) = “client”
set_attribute(node_type, fbi) = “router”
set_attribute(node_type, langley) = “server”
set_attribute(link_data_rate, area51-fbi) = “308 Mb/s”
set_attribute(link_data_rate, fbi-langley) = “348 Mb/s”
set_attribute(link_delay, area51-fbi) = “355 ms”
set_attribute(link_delay, fbi-langley) = “360 ms”
set_attribute(simulation_time_seconds) = “612”

ModelB and ModelC can be specified in a similar way. The corresponding masked model ModelA* can be given by:

network_name: mynetwork
network_nodes: nodea, nodew, nodec
network_links: link1, link2
network_link_endpoints(link1): nodex1, nodex2
network_link_endpoints(link2): nodex3, nodex4
set_attribute(link_type, link1) = “bidirectional”
set_attribute(link_type, link2) = “bidirectional”
set_attribute(node_type, nodea) = “client”
set_attribute(node_type, nodew) = “router”
set_attribute(node_type, nodec) = “server”
set_attribute(link_data_rate, link1) = “123 b/s”
set_attribute(link_data_rate, link2) = “4 b/s”
set_attribute(link_delay, link1) = “5 ms”
set_attribute(link_delay, link2) = “6 ms”
set_attribute(simulation_time_seconds) = “7”

The corresponding translation table for ModelA is given by Table 1 described above. The obfuscated simulation network model representation for ModelA, as provided by the obfuscation engine to the code generation service, is given by {ModelA*, ModelB*, ModelC*}, where ModelB* and ModelC* are similar to ModelA*.

The set of obfuscated code generated by the code generation service is given by {CodeA*, CodeB*, CodeC*}. In an example where code is generated to conform to the API of the ns-3 simulation package, CodeA* can be as follows:

NS_LOG_COMPONENT_DEFINE (“mynetwork”);
int main (int argc, char *argv[ ])
{
NodeContainer clientNode_nodea;
clientNode_nodea.Create(1);
NodeContainer routerNode_nodew;
routerNode_nodew.Create(1);
NodeContainer serverNode_nodec;
serverNode_nodec.Create(1);
PointToPointHelper p2pHelper_link1, p2pHelper_link2;
p2pHelper_link1.SetDeviceAttribute (“DataRate”, DataRateValue
(DataRate (“1.23 b/s”)));
p2pHelper_link1.SetChannelAttribute (“Delay”, TimeValue
(MilliSeconds (5)));
p2pHelper_link2.SetDeviceAttribute (“DataRate”, DataRateValue
(DataRate (“4 b/s”)));
p2pHelper_link2.SetChannelAttribute (“Delay”, TimeValue
(MilliSeconds (6)));
NetDeviceContainer devices_link1, devices_link2;
devices_link1 = p2pHelper_link1.Install (clientNode_nodea,
routerNode_nodew);
devices_link2 = p2pHelper_link2.Install (routerNode_nodew,
serverNode_nodec);
Simulator::Stop (Seconds (7));
Simulator::Run ( );
Simulator::Destroy ( );
return 0;
}

CodeB* and CodeC* are similar to CodeA*. The set of obfuscated code {CodeA*, CodeB*, CodeC*} is provided by the code generation service to the clarification engine.

Upon receiving the set of obfuscated code {CodeA*, CodeB*, CodeC*}, the clarification engine first deletes CodeB* and CodeC* realizing that these obfuscated programs correspond to superfluous network models. The remaining obfuscated code, CodeA*, is then unmasked by the clarification engine using the translation table given by Table 1. The resulting normal unobfuscated ns-3 code for CodeA corresponding to ModelA is then given by:

```
NS_LOG_COMPONENT_DEFINE (“cia-network”);
int main (int argc, char *argv[ ])
{
NodeContainer clientNode_area51;
clientNode_area51.Create(1);
NodeContainer routerNode_fbi;
routerNode_fbi.Create(1);
NodeContainer serverNode_langley;
serverNode_langley.Create(1);
PointToPointHelper p2pHelper_area51-fbi, p2pHelper_fbi-langley;
p2pHelper_area51-fbi.SetDeviceAttribute (“DataRate”, DataRateValue
(DataRate (“308 Mb/s”)));
p2pHelper_area51-fbi.SetChannelAttribute (“Delay”, TimeValue
(MilliSeconds (355)));
p2pHelper_fbi-langley.SetDeviceAttribute (“DataRate”, DataRateValue
(DataRate (“348 Mb/s”)));
p2pHelper_fbi-langley.SetChannelAttribute (“Delay”, TimeValue
(MilliSeconds (360)));
NetDeviceContainer devices_area51-fbi, devices_fbi-langley;
devices_area51-fbi = p2pHelper_area51-fbi.Install (clientNode_area51,
    routerNode_fbi);
devices_fbi-langley = p2pHelper_fbi-langley.Install (routerNode_fbi,
    serverNode_langley);
Simulator::Stop (Seconds (612));
Simulator::Run ( );
Simulator::Destroy ( );
return 0;
}
```

### Example 2

A non-limiting example described below can serve to illustrate the process of model decomposition. Consider the network simulation code provided in Example 1 for ModelA that may have been written by a network simulation code generation program. To facilitate model decomposition, the code generation program may have been written in a manner that better promotes model decomposition. For example, the code generation program may have been written in such a manner as to generate the following logically equivalent simulation code that is generated in two parts:

```
// start of Part 1
NS_LOG_COMPONENT DEFINE (“cia-network”);
int main (int argc, char *argv[ ])
{
NodeContainer clientNode_area51;
clientNode_area51.Create(1);
NodeContainer routerNode_fbi;
routerNode_fbi.Create(1);
PointToPointHelper p2pHelper_area51-fbi;
p2pHelper_area51-fbi.SetDeviceAttribute (“DataRate”, DataRateValue
(DataRate (“308 Mb/s”)));
p2pHelper_area51-fbi.SetChannelAttribute (“Delay, TimeValue
(MilliSeconds (355)));
NetDeviceContainer devices_area51-fbi;
devices_area51-fbi = p2pHelper_area51-fbi.Install (clientNode_area51,
    routerNode_fbi);
// end of Part 1
//
// start of Part 2
NodeContainer serverNode_langley;
serverNode_langley.Create(1);
PointToPointHelper p2pHelper_fbi-langley;
p2pHelper_fbi-langley.SetDeviceAttribute (“DataRate”, DataRateValue
(DataRate (“348 Mb/s”)));
p2pHelper_fbi-langley.SetChannelAttribute (“Delay”, TimeValue
(MilliSeconds (360)));
NetDeviceContainer devices_fbi-langley;
devices_ fbi-langley = p2pHelper_fbi-langley.Install (routerNode_fbi,
    serverNode_langley);
Simulator::Stop (Seconds (612));
Simulator::Run ( );
Simulator::Destroy ( );
return 0;
}
// end of Part 2
```

Since Part 1, as delineated above, only requires model information relating to “area51” and “fbi” and Part 2, as delineated above, only requires model information relating to “fbi” and “langley”, the model ModelA can be decomposed into the two sub-models, subModelA_1 and subModelA_2, as follows:

//subModelA_1
network_name: cia-network
network_nodes: area51, fbi
network_links: area51-fbi
network_link_endpoints(area51-fbi): area51, fbi
set_attribute(link_type, area51-fbi) = “bidirectional”
set_attribute(node_type, area51) = “client”
set_attribute(node_type, fbi) = “router”
set_attribute(link_data_rate, area51-fbi) = “308 Mb/s”
set_attribute(link_delay, area51-fbi) = “355 ms”
//subModelA_2
network_nodes: langley
network_links: fbi-langley
network_link_endpoints(fbi-langley): fbi, langley
set_attribute(link_type, fbi-langley) = “bidirectional”
set_attribute(node_type, langley) = “server”
set_attribute(link_data_rate, fbi-langley) = “348 Mb/s”
set_attribute(link_delay, fbi-langley) = “360 ms”
set_attribute(simulation_time_seconds) = “612”

Since each sub-model only contains a portion of the network model information, one code generation program can be written to or configured to generate Part 1 of the simulation code using the network information contained in subModelA_1 and a second code generation program can be written to or configured to generate Part 2 of the simulation code using the network information contained in subModelA_2. The two simulation code parts can then be concatenated in order by the clarification engine to form a complete body of simulation code.

By allowing a user to generate a usable body of network simulation code using the combination of the obfuscation engine, a cloud-based code generation service provider, and the clarification engine, a user is able to avail themselves of general benefits of using a cloud-based service while being assured that certain network model information is masked or at least obscured in the cloud. Without such assurances, a user may be unwilling or prohibited to use a cloud-based service for network simulation code generation.

The benefits to a user of a cloud-based code generation service compared to using user-based code generation software include the following: (i) a user does not have to install or update code generation software when software patches or updates are released by a code generation software provider or when a user would like to use a newer release of code generation software, and (ii) a cloud-based generation service improves the accessibility of the code generation function for users since it decouples the physical location of the running of the generation function from that of the user.

A software provider of network simulation code generation software can also acquire benefits by providing their code generation functionality in a cloud-based computing environment following a “software-as-a-service” (SaaS) paradigm. Benefits include the following: (i) a cloud-based code generation service simplifies maintenance, updating, and releasing tasks for a software provider since, with a cloud-based service, the software can be installed in the cloud at one location, and (ii) licensing and distribution processes of a software provider can be simplified.

FIG. 1 illustrates an exemplary system 100 that includes user systems 110a, 110b, and 110c, a network 105, and a cloud-based computing environment 120. The cloud-based computing environment 120 may include one or more network simulation code generation engines, for example code generation engines 155a and 155b. The cloud-based computing environment may also include network simulation code generation programs and/or a set of network simulation code generation subprograms 170 that can be provided to a code generation engine 155a and a surrogate value list 165 that can be created by the code generation engine 155a. The user system 110a may include various components, for example a network model obfuscation engine 135, a code clarification engine 175, a translation table 140 and a blank field list 145 that can be created by the obfuscation engine 135 and provided to the clarification engine 175, referenced subprogram information 190 that can be provided by a service provider, and a network model label 180 that can be provided to the clarification engine 175 by the obfuscation engine 135.

The user system 110a can include any type of electronic device, such as a computer (e.g., desktop computer, notebook computer, tablet computer, etc.), a personal digital assistant (PDA), a smartphone, a server, and so forth. The user systems 110a, 110b, 110c and the cloud-based computing environment 120 are able to communicate over a network 105, which can include a public network (e.g., the Internet, a wireless network, etc.), a private network (e.g., a local area network, wide area network, etc.), or some combination thereof. The user system 110a also includes a network model 130 provided by a user to the obfuscation engine 135. The output of the obfuscation engine 135 is provided as an obfuscated model representation 150. The obfuscated model representation 150 is communicated to the cloud-based computing environment 120 over the network 105 and is provided to one or more of the code generation engines 155a, 155b.

The output of the code generation engine 155a can be provided as a body of obfuscated network simulation code 160. The cloud-based computing environment 120 includes a surrogate value list 165 that can be appended to the body of obfuscated network simulation code 160. The body of obfuscated network simulation code 160 provided by the code generation engine 155a can be communicated from the cloud-based computing environment 120 to the corresponding user system 110a over the network 105 and is provided to the code clarification engine 175 of the user system 110a. The output of the code clarification engine 175 is provided as a body of normal unobfuscated network simulation code 185. The body of normal network simulation code is available to the user for use via the user system 110a. The user systems 110b and 110c may include components similar to those illustrated in connection with the user system 110a, and may also perform similar functionalities. The code generation engine 155b may perform functionalities similar to those described in connection with the code generation engine 155a.

In one embodiment, the network model 130 can be represented by an XML (Extensible Markup Language) file. In another embodiment, a network model 130 can be represented in another format such as an XNDL (XML Network Description Language) file as defined in L. E. Banks, et al. “XML Network Description Language (XNDL) for ns-3,” a CSV (comma separated variable) file, a flat file, or as a C++ object or other type of data structure that can be stored in a file.

A general purpose cloud infrastructure computing service such as Amazon Web Services or Google App Engine may be employed by embodiments to realize the cloud-based computing environment 120. In some embodiments, the cloud-based computing environment 120 may be the private cloud-based computing infrastructure of a corporation, government agency, or military organization. Alternatively, the cloud-based computing environment 120 may be implemented on a server computer or on a distributed arrangement of server computers. The cloud-based computing environment 120 may also be a virtual environment and/or may employ the services of more than one general purpose cloud infrastructure computing service.

In one embodiment, an obfuscated network model representation 150, as a whole, may be encrypted prior to being communicated from the user system 110a to the code generation engine 155a. In another embodiment, obfuscated simulation code 160, as a whole, may be encrypted prior to being communicated from the code generation engine 155a to the user system 110a. Such encryptions may utilize public-key cryptography. In an embodiment, the communications over the network 105 may be over HTTP, HTTPS, FTP, SSH, email, secure email, or proprietary protocols.

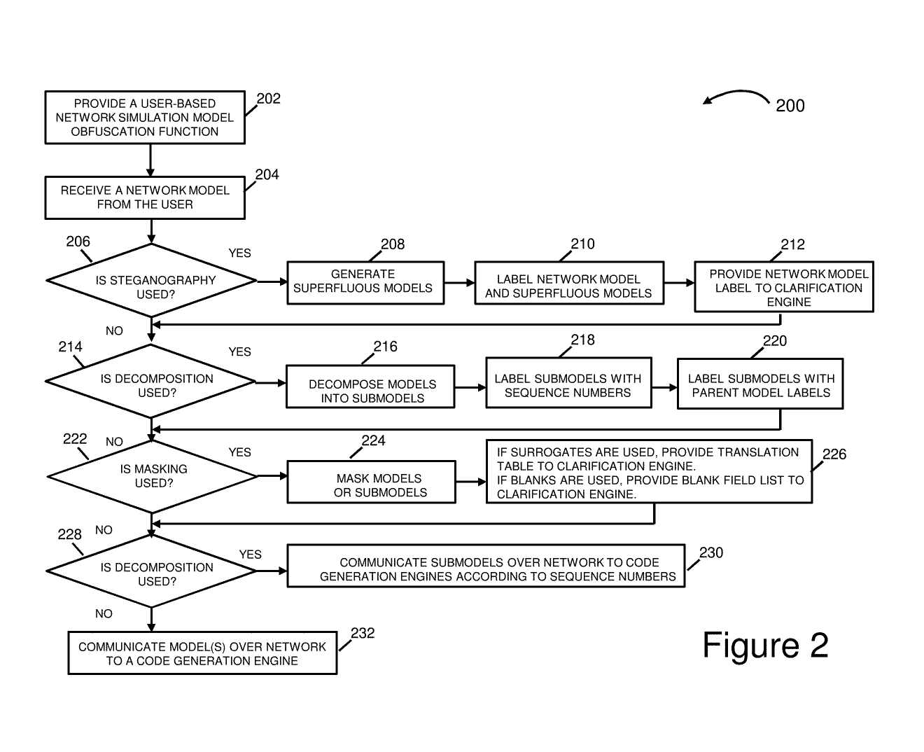

FIG. 2 is a flow diagram of a process 200 according to some embodiments. The process 200 may be performed by the user system 110a of FIG. 1.

At step 202, the user system 110a provides a network model obfuscation function. In response to receiving a network simulation model from the user at step 204, the engine generates an obfuscated model. If steganography is used (step 206), then at step 208 the obfuscation engine generates a set of superfluous network models. At step 210, the obfuscation engine labels the original network model and the superfluous network models with unique model identifiers. At step 212 the obfuscation engine provides the label of the original model to the clarification engine. If model decomposition is used (step 214), then at step 216 the obfuscation engine uses referenced subprogram information provided by the service provider (190 in FIG. 1) to decompose each network model, including any superfluous network models, into an ordered set of sub-models. At step 218 the obfuscation engine labels the sub-models in each set with sequence numbers ranging from 1 to D, where D is the number of sub-models used in the model decomposition method, and also labels each sub-model with the unique label of the corresponding parent model at step 220. If masking is used (step 222), then at step 224 all models or sub-models are masked. If surrogate representations are used in the masking, then at step 226 a translation table is created and provided to the clarification engine. If blank representations are used, then a blank field list containing the identity of the blank fields and their corresponding original option choices or parameter values is created and provided to the clarification engine. If model decomposition is used (step 228), then at step 230 the obfuscation engine communicates the sub-models over the network (105 in FIG. 1) to a set of D code generation engines numbered 1, . . . , D, where a sub-model labeled with sequence number i is provided to the code generation engine numbered i. If model decomposition is not used, then at step 232 all models are communicated over the network to any one of the code generation engines. The process 200 of FIG. 2 can be repeated for other network simulation models provided by the user.

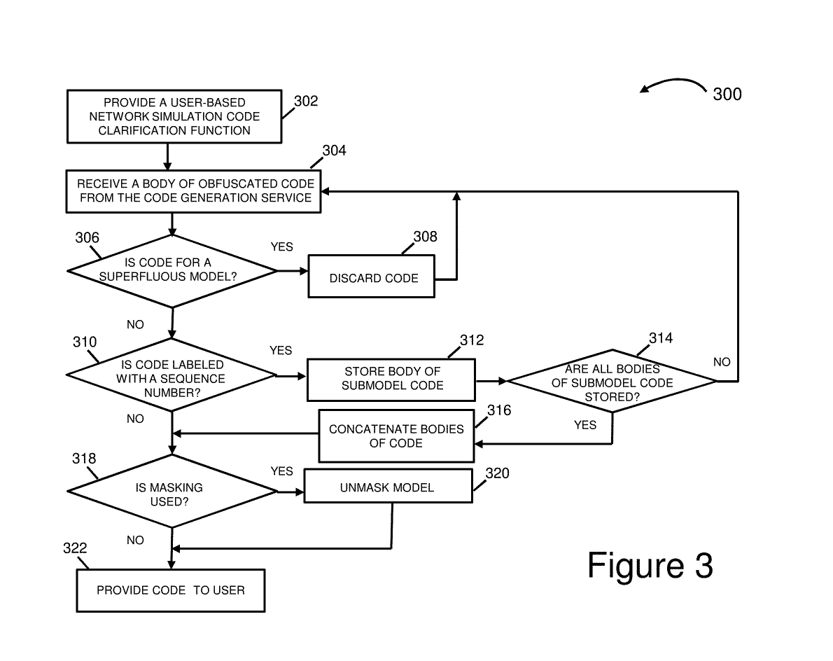

FIG. 3 is a flow diagram of a process 300 according to some embodiments. The process 300 may be performed by the user system 110a of FIG. 1. At step 302, the user system 110a provides a network simulation code clarification function. In response to receiving a body of obfuscated network simulation code from the code generation service at step 304, the clarification engine determines whether the received code is superfluous at step 306. If yes, then at step 308 the clarification engine discards the body of code, and the process 300 returns to step 304. If the body of code is not superfluous, and is labeled with a sequence number (step 310), then the body corresponds to a sub-model and the body of code is stored at step 312. At step 314, the clarification engine determines if all bodies of code corresponding to sub-models have been stored for a network model decomposition. If no, then the process 300 returns to step 304. If all bodies of obfuscated code have been stored for a network model decomposition, then at step 316 the clarification engine concatenates the stored bodies of code in the order of their sequence numbers to form a complete body of code.

Continuing with FIG. 3, if masking is used (step 318), then the clarification engine unmasks any model option choices or parameter values that have been masked at step 320. A model option choice or parameter value that has been masked by the obfuscation engine using a surrogate representation, is unmasked using the translation table (140 in FIG. 1) that has been provided by the obfuscation engine. A model option choice or parameter value that has been masked by the obfuscation engine using a blank representation, is unmasked using the blank field list (145 in FIG. 1) provided by the obfuscation engine and the surrogate value list (165 in FIG. 1) that has been appended to the body of obfuscated code provided by a code generation engine. A model option or parameter that has been masked using encryption is decrypted. The resulting body of clarified network simulation code is then provided to the user at step 322. The process 300 of FIG. 3 can be repeated for other bodies of obfuscated code received by the user system 110a from the code generation service.

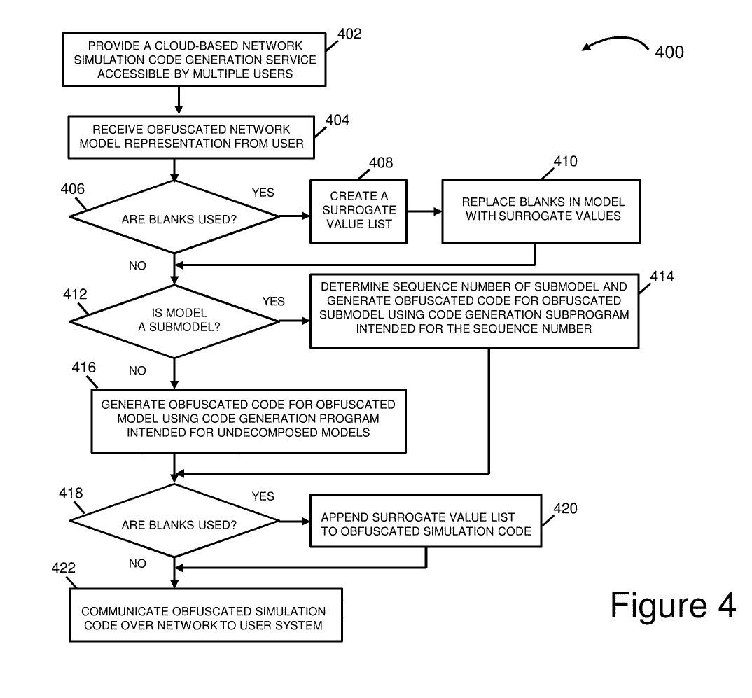

FIG. 4 is a flow diagram of a process 400 according to some embodiments. The process may be performed by the cloud-based computing environment 120 of FIG. 1. At step 402, the cloud-based computing environment 120 provides a network simulation code generation service that is accessible by multiple users. In response to receiving an obfuscated network model representation from a user system at step 404, a code generation engine determines if blank representations are used in the obfuscated model (step 406). If blanks are used, then at step 408 the code generation engine creates a surrogate value list that contains the specific model options or parameter fields that have been identified as being blank and the corresponding distinct surrogate values that the code generation engine generates to represent blank fields. At step 410, the code generation engine replaces the blanks in the received obfuscated network model representation with the corresponding surrogate values in the surrogate value list. At step 412, the code generation engine determines if the model representation corresponds to that of a sub-model. If the model representation is a sub-model, then at step 414 the code generation engine determines the sequence number of the sub-model from the sequence number label of the sub-model and generates a body of obfuscated network simulation code using the code generation subprogram that is intended for a sub-model corresponding to the sequence number. The process 400 then continues to step 418. If the model representation is not a sub-model, then at step 416 the code generation engine generates a body of obfuscated network simulation code using the code generation program that is intended for network models that have not been decomposed. If masking with blanks is used in the received model representation (step 418), then at step 420 the surrogate value list is appended to the generated body of obfuscated network simulation code. The obfuscated code is then communicated over the network to the user system at step 422. The process 400 of FIG. 4 can be repeated for other obfuscated network model representations received from other user systems 110a, 110b, or 110c.

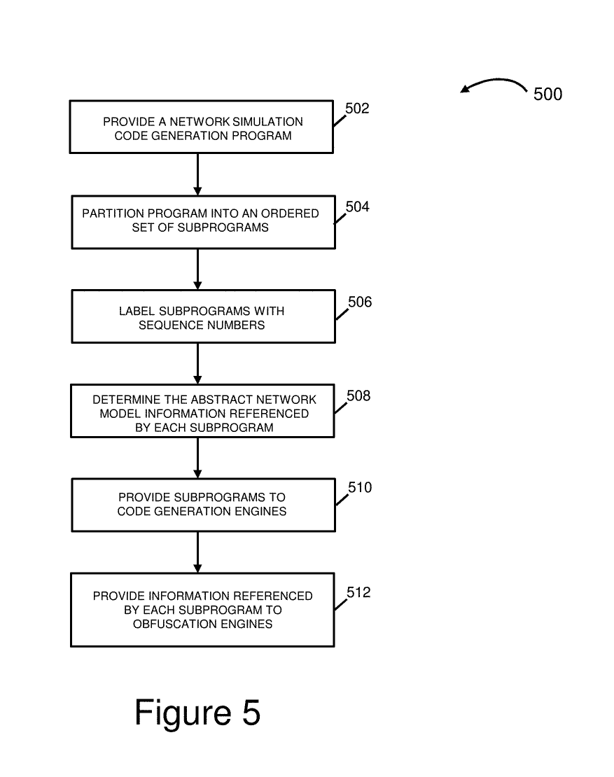

FIG. 5 is a flow diagram of a process 500 according to some embodiments. The process 500 may be performed off-line by a network simulation code generation service provider. At step 502, a network simulation code generation program is provided by a network simulation code generation service provider. At step 504, the program is partitioned into an ordered set of S subprograms, where the number of partitions is a parameter that can be selected by the service provider. At step 506, the subprograms are labeled with a sequence number corresponding to their order in the partitioning. At step 508, a set of information A(i) is determined for each subprogram i, where the set A(i) consists of the abstract network model information that is referenced by the corresponding subprogram i and i=1, . . . , S. The labeled subprograms are provided to each code generation engine at step 510.

The sets of subprogram information A(1), . . . , A(S) are provided to obfuscation engines at step 512.

FIG. 6 illustrates example network models, for example, ModelA, ModelB, and ModelC, which were used to describe non-limiting examples above.

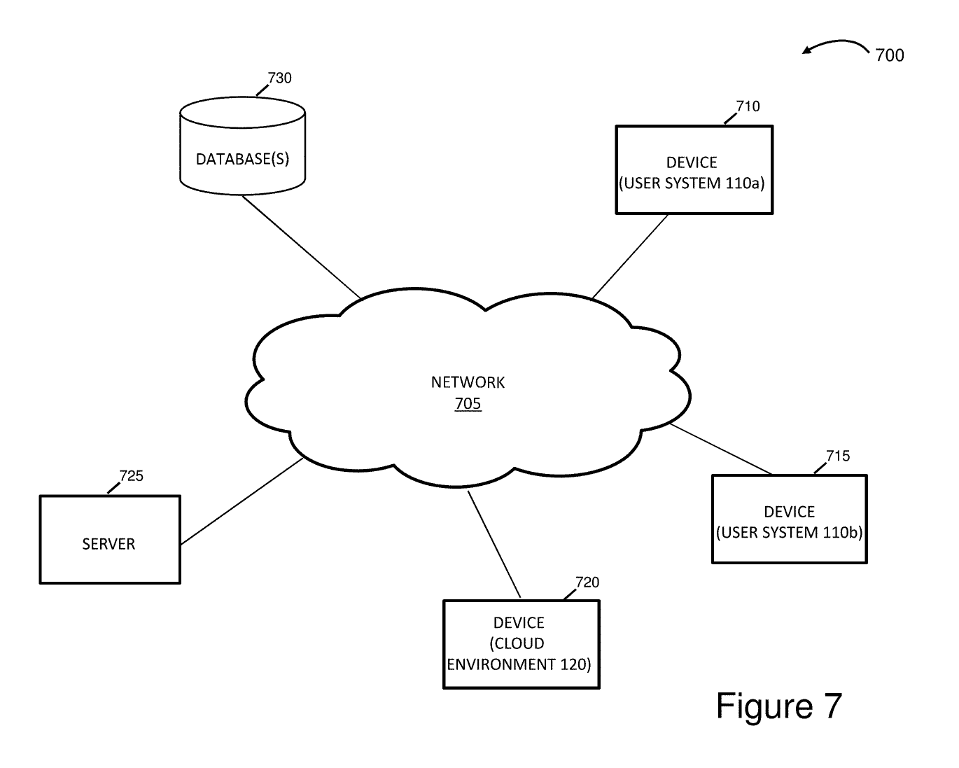

FIG. 7 illustrates a network diagram depicting a system 700 for implementing the cloud-based service of providing a network simulation code, according to an example embodiment. The system 700 can include a network 705, multiple devices, for example, device (user system) 710, device (user system) 715, device (cloud environment) 720, server 725, and a database(s) 730. Each of the devices 710, 715, 720, server 725, and database(s) 730 is in communication with the network 705. In an example embodiment, one or more portions of network 705 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

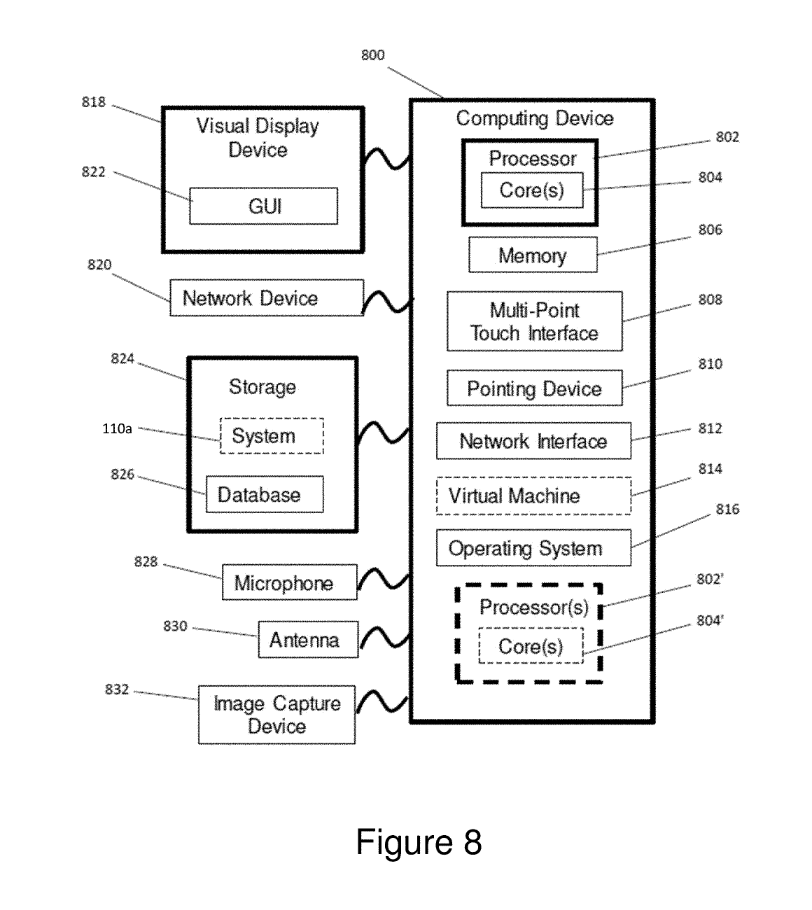

The devices 710, 715, 720 may comprise, but are not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, smartphones, tablets, netbooks, and the like. The device 710, 715, 720 may include one or more components of computing system 800 described in connection with FIG. 8. Each of devices 710, 715, 720 may connect to network 705 via a wired or wireless connection.

System 700 is a distributed representation of the system 100 shown in FIG. 1. Device 710 and 715 may include the user system, for example user system 110a or 110b. Description of the user system 110a or 110b can be found above in connection with FIG. 1. Device 720 may include the cloud environment, for example cloud computing environment 120. Description of the cloud computing environment 120 can be found above in connection with FIG. 1. Each of devices 710 and 715 may include one or more applications such as, but not limited to, an obfuscation engine, a clarification engine, a web browser application, and the like. Device 720 may include one or more applications, such as, but not limited to a code generation engine, a web-browser application, and the like.

In an example embodiment, the devices 710, 715, 720 may perform all the functionalities described herein. In other embodiments, the server 725 performs the functionalities described herein. In yet another embodiment, the device 710, 715, 720 may perform some of the functionalities, and server 725 performs the other functionalities described herein.

Each of the database(s) 730, and server 725 is connected to the network 705 via a wired connection. Alternatively, one or more of the database(s) 730, and server 725 may be connected to the network 705 via a wireless connection. Although not shown, server 725 can be (directly) connected to the database(s) 730. Server 725 comprises one or more computers or processors configured to communicate with devices 710, 715, 720 via network 705. Server 725 hosts one or more applications or websites accessed by devices 710, 715, 720 and/or facilitates access to the content of database(s) 730. Database(s) 730 comprise one or more storage devices for storing data and/or instructions (or code) for use by server 725, and/or devices 710, 715, 720. Database(s) 730, and/or server 725 may be located at one or more geographically distributed locations from each other or from devices 710, 715, 720. Alternatively, database(s) 730 may be included within server 725. Device 710 and 715 may be user systems 110a, 110b or 110c described in connection with FIG. 1. Device 720 may be cloud computing environment 120 described in connection with FIG. 1.

FIG. 8 is a block diagram of an exemplary computing device 800 that may be used to implement exemplary embodiments of the system 100 described herein. The computing device 800 may be used to implement the user system 110a of the system 100. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 806 included in the computing device 800 may store computer-readable and computer-executable instructions or software for implementing exemplary embodiments of the system 100, including user system 110a. The computing device 800 also includes configurable and/or programmable processor 802 and associated core 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for controlling system hardware. Processor 802 and processor(s) 802′ may each be a single core processor or multiple core (804 and 804′) processor.

Virtualization may be employed in the computing device 800 so that infrastructure and resources in the computing device may be shared dynamically. A virtual machine 814 may be provided to handle a process running on multiple processors so that the process appears to be using only one computing resource rather than multiple computing resources. Multiple virtual machines may also be used with one processor. Memory 806 may include a computer system memory or random access memory, such as DRAM, SRAM, EDO RAM, and the like. Memory 806 may include other types of memory as well, or combinations thereof. A user may interact with the computing device 800 through a visual display device 818, such as a computer monitor, which may display one or more graphical user interfaces 822 that may be provided in accordance with exemplary embodiments. The computing device 800 may include other I/O devices for receiving input from a user, for example, a keyboard or any suitable multi-point touch interface 808, a pointing device 810 (e.g., a mouse), a microphone 828, and/or an image capturing device 832 (e.g., a camera or scanner). The multi-point touch interface 808 (e.g., keyboard, pin pad, scanner, touch-screen, etc.) and the pointing device 810 (e.g., mouse, stylus pen, etc.) may be coupled to the visual display device 818. The computing device 800 may include other suitable conventional I/O peripherals.

The computing device 800 may also include one or more storage devices 824, such as a hard-drive, CD-ROM, or other computer readable media, for storing data and computer-readable instructions and/or software that implement exemplary embodiments of the system 100 described herein. Exemplary storage device 824 may also store one or more databases for storing any suitable information required to implement exemplary embodiments. For example, exemplary storage device 824 can store one or more databases 826 for storing information to be used by embodiments of the system 100. Storage device 824 may also store components of user system 110a described above in connection with FIG. 1. The databases may be updated manually or automatically at any suitable time to add, delete, and/or update one or more items in the databases.

The computing device 800 can include a network interface 812 configured to interface via one or more network devices 820 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 800 can include one or more antennas 830 to facilitate wireless communication (e.g., via the network interface) between the computing device 800 and a network. The network interface 812 may include a built-in network adapter, network interface card, PCMCIA network card, card bus network adapter, wireless network adapter, USB network adapter, modem or any other device suitable for interfacing the computing device 800 to any type of network capable of communication and performing the operations described herein. Moreover, the computing device 800 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 800 may run any operating system 816, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 816 may be run in native mode or emulated mode. In an exemplary embodiment, the operating system 816 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A method for securely providing a code generation service implemented in a cloud computing environment, the method comprising:
receiving a network model from a user;
generating an obfuscated network model based on the network model;
transmitting the obfuscated network model to a network simulation code generation service implemented in a cloud computing environment;
receiving network simulation code generated from the obfuscated network model; and
generating unobfuscated network simulation code from the received network simulation code based on the obfuscated network model.

2. The method of claim 1, wherein the network model received from the user comprises a plurality of original values representing network components, wherein the one or more original values includes at least one of a node name, a link name, and a network name.

3. The method of claim 1, wherein the obfuscated network model is generated by masking data in the network model received from the user.

4. The method of claim 3, wherein masking data includes replacing an original value in the network model received from the user with one or more surrogate values.

5. The method of claim 3, wherein the unobfuscated network simulation code is generated based on unmasking the masked data.

6. The method of claim 1, further comprising:
generating a set of superfluous network models; and
transmitting the set of superfluous network models with the obfuscated network model to the network simulation code generation service.

7. The method of claim 6, further comprising:
discarding the network simulation code generated from the set of superfluous network models; and
generating the unobfuscated network simulation code for the network simulation code received from the network simulation code generation service.

8. The method of claim 1, further comprising:
decomposing the network model received from the user into two or more sub-models;
generating a set of obfuscated network models based on each of the two or more sub-models; and
transmitting the set of obfuscated network models to the network simulation code generation service.

9. The method of claim 8, further comprising:
receiving a set of network simulation codes based on the set of obfuscated network models;
composing a network simulation code, that corresponds to the network model received from the user, from the set of network simulation code; and
generating the unobfuscated network simulation code for the composed network simulation code.

10. A system for securely providing a network code generation service via a cloud computing environment, the system comprising:
an obfuscation engine configured to:
receive a network model from a user;
generate an obfuscated network model based on the network model;
transmit the obfuscated network model to a network simulation code generation service implemented in a cloud computing environment; and
a clarification engine configured to:
receive network simulation code generated from the obfuscated network model; and
generate unobfuscated network simulation code from the received network simulation code based on the obfuscated network model.

11. The system of claim 10, wherein the network model received from the user comprises a plurality of original values representing network components, wherein the one or more original values includes at least one of a node name, a link name, and a network name.

12. The system of claim 10, wherein the obfuscation engine generates the obfuscated network model by masking data in the network model received from the user.

13. The system of claim 12, wherein masking data includes replacing an original value in the network model received from the user with one or more surrogate values.

14. The system of claim 12, wherein the clarification engine generates the unobfuscated network simulation code based on unmasking the masked data.

15. The system of claim 10, wherein the obfuscation engine is further configured to:
generate a set of superfluous network models; and
transmit the set of superfluous network models with the obfuscated network model to the network simulation code generation service.

16. The system of claim 15, wherein the clarification engine is further configured to:
discard the network simulation code generated from the set of superfluous network models; and
generate the unobfuscated network simulation code for the network simulation code received from the network simulation code generation service.

17. The system of claim 10, wherein the obfuscation engine is further configured to:
decompose the network model received from the user into two or more sub-models;
generate a set of obfuscated network models based on each of the two or more sub-models; and
transmit the set of obfuscated network models to the network simulation code generation service.

18. The system of claim 17, wherein the clarification engine is further configured to:
receive a set of network simulation codes based on the set of obfuscated network models;
compose a network simulation code, that corresponds to the network model received from the user, from the set of network simulation code; and
generate the unobfuscated network simulation code for the composed network simulation code.

19. A non-transitory machine-readable medium storing instructions executable by a processing device, wherein execution of the instructions causes the processing device to implement a method for securely providing a network simulation code generation service via a cloud computing environment, the method comprising:
receiving a network model from a user;
generating an obfuscated network model based on the network model;
transmitting the obfuscated network model to a network simulation code generation service implemented in a cloud computing environment;
receiving network simulation code generated from the obfuscated network model; and
generating unobfuscated network simulation code from the received network simulation code based on the obfuscated network model.

20. The non-transitory machine readable medium of claim 19, wherein the network model received from the user comprises a plurality of original values representing network components, wherein the one or more original values includes at least one of a node name, a link name, and a network name.

21. The non-transitory machine readable medium of claim 19, wherein the obfuscated network model is generated by masking data in the network model received from the user.

22. The non-transitory machine readable medium of claim 21, wherein masking data includes replacing an original value in the network model received from the user with one or more surrogate values.

23. The non-transitory machine readable medium of claim 21, wherein the unobfuscated network simulation code is generated based on unmasking the masked data.
